(19) United States
(12) Patent Application Publication
(10) Pub. No.: US 2026/0084893 A1
(43) Pub. Date: Mar. 26, 2026

(54) Guide System for Cargo Track Head Interface

(71) Applicants: Prime Design Engineering Ltd, Bridgend (GB); Doleco USA, Inc., Meriden, CT (US)

(72) Inventor: Richard Jones, Bridgend (GB)

(73) Assignees: Prime Design Engineering Ltd, Bridgend (GB); Doleco USA, Inc., Meriden, CT (US)

(21) Appl. No.: 19/326,042

(22) Filed: Sep. 11, 2025

Related U.S. Application Data
(60) Provisional application No. 63/698,583, filed on Sep. 25, 2024.
(60) Provisional application No. 63/813,862, filed on May 29, 2025.

(51) Int. Cl. B65D 90/00; B62D 53/06

(52) U.S. Cl. CPC B65D 90/0073; B62D 53/067; B65D 2590/005

(57) ABSTRACT

A wear guide for cargo track systems comprises a body configured to be positioned between a foot's engagement portion and a track's guide recess, creating a protective interface that prevents metal-to-metal contact. The body includes at least one interface member positioned at one end to inhibit edge contact and binding during translation along the track. The interface member may extend beyond the foot edge. Retention features include end caps and through-holes for fasteners. The foot may define recessed sections dimensioned to receive the wear guide such that it projects beyond the foot's original engagement surface, providing the primary contact interface with the track. The system reduces wear, prevents galling and binding at critical edge locations, extends component life, and enables smooth translation while being field-replaceable without requiring replacement of expensive structural components.

### TECHNICAL FIELD

The present disclosure generally relates to the field of cargo control and more specifically to a system of adjustable load beams that provide decking to divide the cargo container into multiple levels of payload.

### BACKGROUND

In freight transportation, maximizing the utilization of available space within cargo containers is crucial for operational efficiency and cost-effectiveness. To achieve this, it is common practice to stack cargo in multiple levels, taking full advantage of the vertical space in cargo containers such as truck trailers, aircraft cargo holds, railroad cars, and other similar cargo enclosures. This multi-level stacking approach necessitates the use of robust and versatile decking systems.

At the heart of these decking systems are movable decking beams, designed to support substantial payload weights while offering flexibility in cargo arrangement. These beams are typically adjustable, allowing for repositioning at various heights and horizontal intervals within the cargo container. This adaptability is essential to accommodate the diverse sizes and shapes of cargo items transported across different industries.

A conventional cargo beam and decking system, as illustrated in FIG. 1, comprises several key components. The system includes a series of vertical mounting tracks 10 that line the walls along the length of the cargo container. These tracks feature a sequence of openings or slots, enabling the adjustment of decking beam heights to suit specific cargo requirements. In a typical configuration, multiple decking beams 20 span the width of the container, creating supportive platforms for upper layers of cargo pallets 30.

The adjustable decking beam itself, depicted in FIG. 2, consists of several parts working in concert. The beam 40 comprises a central hollow section 50, flanked by two adjustable end pieces 60, 70 that can slide within the beam's ends. Each of these end pieces terminates in a “foot” 65, 75 designed to engage with the vertical mounting tracks on the container walls. These feet incorporate trigger-operated locking mechanisms 80 that interface with the openings in the mounting tracks, allowing for secure positioning of the beams at desired heights.

The decking system described herein may be known by various names in the industry, including, but not limited to: load bars, E-track load bars, decking beams, logistic beams, cargo bars, captive decking, level loading system, multi-level loading system, freight loading system, E-track decking system, adjustable deck system, double-deck system, and freight bar system. Various manufacturers may utilize proprietary names for similar systems, such as Ancra Cargo Beam System, Kinedyne K2 Decking System, Whiting CommandGlide, and SafetyWeb Decking System. While these systems may be known by different names, they generally refer to the same fundamental concept of adjustable horizontal beams that create multiple loading levels within a trailer, though specific features, mechanisms, and implementations may vary between manufacturers and models.

While the decking system described herein is particularly useful in truck trailers, it should be understood that such systems may be implemented in various cargo-carrying spaces and vehicles, including, but not limited to: shipping containers, railway cars, cargo vans, delivery vehicles, storage facilities, warehouses, shipping vessels, aircraft cargo holds, intermodal containers, fixed storage units, portable storage units, and other enclosed or semi-enclosed spaces where efficient vertical space utilization and cargo organization is desired. The versatility of the decking system allows it to be adapted to various sizes and configurations of cargo spaces, providing similar benefits of improved load capacity, cargo protection, and efficient space utilization across different applications, while accommodating varying dimensional requirements and loading conditions specific to each type of cargo space.

In reference to FIGS. 3A and 3B, a portion of a decking system is shown. Namely, the system includes a track 16 that extends vertically in the cargo space when installed therein. The track 16 is configured for receiving the footing 65 of the beam 40. In the embodiment shown, which is in accordance with the prior art, the footing 65 includes a pair of laterally spaced engagement portions 82, 86 that are dimensioned to be received within corresponding guide recesses 92, 96 defined by the interior walls of the track channel. The engagement portions 82, 86 include locking ribs 84, 88 that cooperate with retaining ledges 94, 98 in the track 16 to inhibit a displacement of the footing 65 from the track 16 in the normal direction and to further inhibit movement of the footing relative to the track in the direction perpendicular to the axis of the track 65 in the plane thereof. The interface between the footing 65 and the track 16 enables the footing to translate relative to the track in along the axis of the track. As is known in the art, the footing can be selectively fixed along the track to provide a fixed support height for a while permitting longitudinal sliding movement. The interlocking geometry ensures stable support of the footing relative to the track under load-bearing conditions.

It will be appreciated that the particular interlocking configuration between the footing 65 and the track 16 as shown in FIGS. 3A and 3B is exemplary and not limiting. Various alternative configurations may be employed to achieve the same functional result of securing the footing within the track while permitting longitudinal adjustability and resisting vertical and lateral displacement. For example, the track may include dovetail channels, T-slot profiles, or inwardly biased retention tabs, and the corresponding footing may be shaped to engage such structures via complementary projections, hooks, or deformable inserts. Likewise, the engagement may be achieved through interference fits, resilient clips, or mechanical fasteners instead of the depicted locking ribs and ledges. The structural and functional relationship between the footing and the track may thus be implemented through a wide range of geometries and materials suited to the particular demands of the decking system, cargo environment, or intended use.

The track 10 extends along a linear axis from a first end to a second end. The track 10 includes a first groove 12 and a second groove 14 configured to receive corresponding elements of a footing, such that footing and the associated beam can translate relative to the track along said axis and also be locked into position relative to said track thereby providing a support

The prior art configuration of cargo track systems presents several significant disadvantages, particularly at the interface between the sliding head and the cargo track. When metal components of similar composition directly contact each other during operation, they are prone to developing excessive wear patterns, galling, and binding. This metal-on-metal contact creates friction that impedes smooth movement and accelerates deterioration of both components.

In traditional configurations, the direct interface between the sliding head and the track results in a high coefficient of friction, requiring greater force for movement and causing premature component failure. This inefficiency translates to increased operational effort, reduced payload capacity, and higher energy consumption during cargo handling operations. Moreover, the wear patterns that develop over time create uneven surfaces that further exacerbate these problems, leading to a progressive decline in system performance.

The prior art configuration also leads to accelerated corrosion at contact points, particularly in environments with temperature fluctuations, moisture exposure, or corrosive elements. This corrosion not only compromises the structural integrity of the system but also introduces additional friction and binding that further inhibits smooth operation.

Maintenance requirements for traditional cargo track systems are considerably demanding due to these limitations. The metal-on-metal interfaces reduces the operative life of the equipment and adds to operational costs and potential environmental concerns. When damage occurs, repairs often necessitate replacement of expensive components rather than just the affected interface surfaces, resulting in higher maintenance expenses and extended downtime periods that impact operational efficiency.

These persistent challenges in conventional cargo track systems highlight the need for an innovative solution that addresses the fundamental issues of friction, wear, material compatibility, and maintenance requirements while enhancing the overall performance and longevity of these essential cargo handling components.

### SUMMARY OF THE INVENTION

The needs set forth herein as well as further and other needs and advantages are addressed by the present teachings, which illustrate solutions and advantages described below.

It is an objective of the present teachings to remedy the above drawbacks and issues associated with conventional cargo track systems where the interface between sliding heads and tracks can lead to excessive wear, galling, binding, and increased maintenance costs.

It is a further objective of the present teachings to remedy the above drawbacks and issues associated with conventional cargo track systems, where articulation of the sliding heads within the track can cause the leading and trailing edges to become the primary contact points, resulting in excessive wear, binding, galling, and increased maintenance costs.

The present invention resides in one aspect in a wear guide for use with an adjustable decking system, the decking system including a foot having an engagement portion and a track defining a guide recess configured to receive the engagement portion such that the foot can translate in a first direction along a length of the track and be selectively fixed relative to the track in said first direction while being constrained relative to the track in a second direction and a third direction, the second direction extending perpendicular to the first direction in a common plane, and the third direction extending normal to the plane, the engagement portion extending between a first end and a second end along the first direction, the engagement portion having a cross-section defining an open channel, the channel including a base portion and opposing first and second arms extending from opposite ends of the base portion to define an opening therebetween, the wear guide comprising a body extending from a first end to a second end, the body defining a shape configured to be received on the foot and positioned between the engagement portion of the foot and the guide recess of the track to form an interface therebetween, a first surface of the body configured to contact the engagement portion of the foot, a second surface of the body configured to contact the guide recess of the track, wherein the body remains fixed relative to the foot when the foot translates in the first direction relative to the track, and wherein the first end of the body extends longitudinally beyond the first end of the engagement portion when the body is fixed to the foot.

In yet a further embodiment of the present invention, the body defines a cross-sectional shape generally corresponding to the open channel of the engagement portion such that the body is received therein.

In yet a further embodiment of the present invention, the body defines a pair of flanges at the first end, the flanges extending in the third direction so as to cover a first edge of the foot at an area of the open channel.

In yet a further embodiment of the present invention, the flanges extend in the third direction along respective portions of the first arm and the second arm of the engagement portion to protect edges thereof.

In yet a further embodiment of the present invention, the body includes an end cap extending from at least one of the first end and the second end, the at least one end cap being configured to wrap around an edge of the open channel of the engagement portion, including distal edges of the opposing first and second arms, so as to inhibit displacement of the wear guide relative to the foot and to prevent direct contact between the engagement portion and the track.

In yet a further embodiment of the present invention, the body comprises end caps positioned at both the first end and the second end of the body.

In yet a further embodiment of the present invention, the body is formed of a material dissimilar to a material of the foot and a material of the track, the material of the body having a coefficient of friction lower than that of the foot and the track.

In yet a further embodiment of the present invention, the body is secured to the engagement portion by an interference fit between the body and the open channel of the engagement portion.

In yet a further embodiment of the present invention, the body defines a through-hole configured to receive a fastener that secures the foot to a beam of the adjustable decking system.

The present invention resides in another aspect in an adjustable decking system comprising a foot having an engagement portion extending between a first end and a second end, the engagement portion having a cross-section defining an open channel, the channel including a base portion and opposing first and second arms extending from opposite ends of the base portion to define an opening therebetween, a track defining a guide recess configured to receive the engagement portion such that the foot can translate in a first direction along a length of the track and be selectively fixed relative to the track in said first direction while being constrained relative to the track in a second direction and a third direction, the second direction extending perpendicular to the first direction in a common plane, and the third direction extending normal to the plane, and a wear guide comprising a body positioned between the engagement portion of the foot and the guide recess of the track to form an interface therebetween, the body extending from a first end to a second end, the body defining a shape generally corresponding to the open channel of the engagement portion such that the body is received therein, wherein the first end of the body extends longitudinally beyond the first end of the engagement portion when the body is fixed to the foot.

In yet a further embodiment of the present invention, the body defines a pair of flanges at the first end, the flanges projecting in the third direction to cover a first edge of the foot at an area of the open channel.

In yet a further embodiment of the present invention, the flanges extend along respective portions of the first arm and the second arm of the engagement portion to protect distal edges thereof.

In yet a further embodiment of the present invention, the body comprises at least one end cap extending from at least one of the first end and the second end, the at least one end cap configured to wrap around an edge of the open channel of the engagement portion, including distal edges of the opposing first and second arms, so as to inhibit displacement of the wear guide relative to the foot and to prevent direct contact between the engagement portion and the track.

In yet a further embodiment of the present invention, the body comprises end caps positioned at both the first end and the second end of the body.

In yet a further embodiment of the present invention, the body defines at least one opening configured to receive a fastener that secures the foot to a beam of the adjustable decking system.

In yet a further embodiment of the present invention, the foot defines at least one recessed section dimensioned to receive a portion of the body such that the body is seated within the recessed section and projects beyond an original engagement surface of the foot to provide a primary contact interface with the track.

In yet a further embodiment of the present invention, the recessed section is located at the first end of the foot and is configured to receive a corresponding portion of the body.

In yet a further embodiment of the present invention, the foot defines a first recessed section at the first end and a second recessed section at the second end, each recessed section configured to receive a corresponding portion of the body.

In yet a further embodiment of the present invention, the recessed section has a depth less than a thickness of the corresponding portion of the body such that the body projects beyond the original engagement surface of the foot when installed.

In yet a further embodiment of the present invention, the recessed section and the body are configured such that the body provides a sole contact interface between the engagement portion of the foot and the guide recess of the track at at least one predetermined contact zone.

The present invention resides in yet another aspect in a wear guide for use with an adjustable decking system, the decking system including a foot having an engagement portion and a track defining a guide recess configured to receive the engagement portion such that the foot can translate in a first direction along a length of the track and be selectively fixed relative to the track in said first direction while being constrained relative to the track in a second direction and a third direction, the second direction extending perpendicular to the first direction in a common plane, and the third direction extending normal to the plane, the engagement portion extending between a first end and a second end along the first direction, the engagement portion having a cross-section defining an open channel, the channel including a base portion and opposing first and second arms extending from opposite ends of the base portion to define an opening therebetween, the wear guide comprising a body extending from a first end to a second end, the body defining a shape configured to be received on the foot and positioned between the engagement portion of the foot and the guide recess of the track to form an interface therebetween, a first surface of the body configured to contact the engagement portion of the foot, a second surface of the body configured to contact the guide recess of the track, and a flange defined at the first end of the body, the flange projecting in the third direction to cover a first edge of the foot at an area of the open channel.

In yet a further embodiment of the present invention, the wear guide comprises a second flange wherein the flanges extend along respective portions of the first arm and the second arm of the engagement portion to protect distal edges thereof.

In yet a further embodiment of the present invention, the body defines at least one opening configured to receive a fastener that secures the foot to a beam of the adjustable decking system.

These and other aspects of the present invention will become apparent in light of the drawings and detailed description provided below.

### BRIEF DESCRIPTION OF THE DRAWINGS

FIG. 1 illustrates a cut-away perspective view of a truck trailer employing a cargo beam and decking system.

FIG. 2 is a side view of an adjustable decking beam.

FIG. 3 is a perspective view of a footing received in a track.

FIG. 4A is an exploded view of a footing and wear guide in accordance with one embodiment of the present invention.

FIG. 4B is an end view of the embodiment shown in FIG. 4A.

FIG. 5A is an exploded perspective view of a footing and wear guide in accordance with one embodiment of the present invention.

FIG. 5B is a front view of the wear guide shown in FIG. 5A.

FIG. 5C is a side view of the wear guide shown in FIG. 5A.

FIG. 5D is a perspective view of the wear guide shown in FIG. 5A.

FIG. 5E is a perspective exploded view of one embodiment of a wear guide in accordance with the present invention, wherein the wear guide

FIG. 6A is a perspective view of one embodiment of a wear guide in accordance with the present invention, wherein the wear guide is received on the footing.

FIG. 6B is a perspective view of the wear guide and footing shown in FIG. 6A, wherein the footing is received in a track and the wear guide provides an interface therebetween.

FIG. 7A is a perspective view of a wear guide and a footing in accordance with one embodiment of the present invention.

FIG. 7B is a perspective view of a wear guide in accordance with one embodiment of the present invention.

FIG. 8A is an end view of the embodiment of the footing and wear guide shown in FIG. 4A.

FIG. 8B is an end view of the embodiment of the footing and wear guide shown in FIG. 9A.

FIG. 9A is a perspective view of a footing and wear guide in accordance with one embodiment of the present invention.

FIG. 9B is an exploded perspective view of the footing and wear guide shown in FIG. 9A

FIG. 10A is a perspective view of a footing and wear guide in accordance with one embodiment of the present invention.

FIG. 10B is an exploded perspective view of the footing and wear guide shown in FIG. 10A

FIG. 10C is an exploded side view of the embodiment shown in FIG. 10A.

FIG. 10D is a side view of the embodiment shown in FIG. 10A

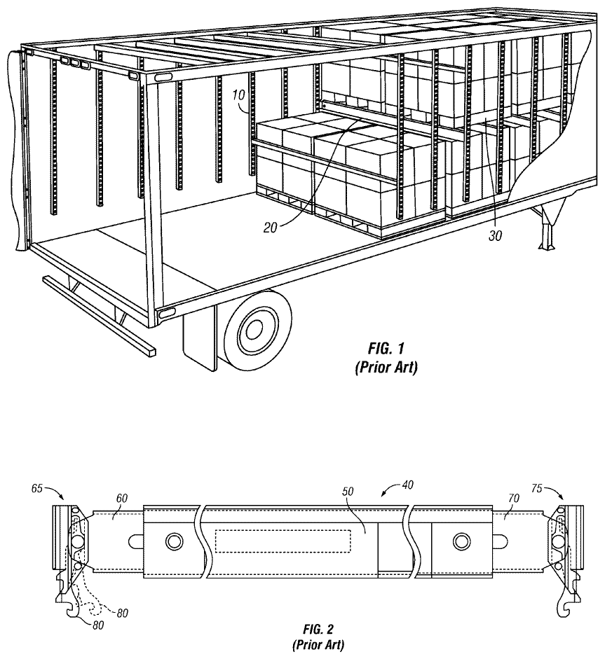

### DETAILED DESCRIPTION

The present invention relates to a wear guide and a method for manufacturing and using the same. This detailed description will provide a comprehensive overview of the invention, its various embodiments, and the manufacturing processes involved.

The present invention provides an innovative wear guide system for cargo track interfaces that addresses the longstanding challenges associated with friction, wear, and binding in cargo track systems. With reference to the exemplary embodiments illustrated in the accompanying drawings, the invention will be described in detail, noting that these embodiments represent just some of the possible implementations of the present invention.

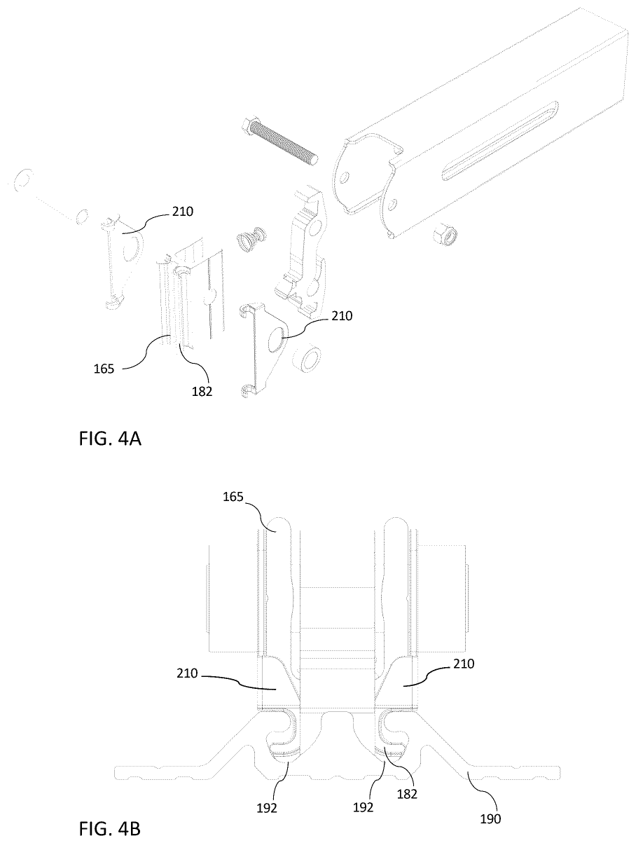

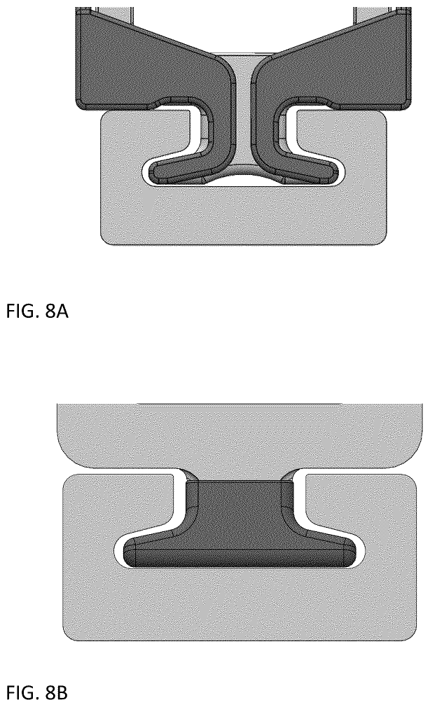

The wear guide system of the present invention is designed for installation on one or both sides of the foot/track interface in decking systems commonly used in shipping containers, truck trailers, aircraft cargo holds, railway cars, and similar cargo-carrying environments. As illustrated in FIGS. 4A through 10D, the wear guide can take various forms and configurations while maintaining its core functionality of reducing friction and preventing wear.

The system is particularly valuable in applications where cargo beams must translate smoothly along tracks to provide adjustable decking or cargo securing capabilities. In such scenarios, the traditional metal-on-metal contact between the sliding head and track creates friction, causes wear, and can lead to binding or edge interference that impedes efficient operation. The present invention addresses these issues by introducing a low-friction interface material that not only protects both components but also shields the leading and trailing edges of the head from binding or digging into the track during articulation and movement, thereby ensuring smooth and reliable operation.

The inventors have made a significant discovery regarding the optimal positioning of wear guides for maximum effectiveness in cargo track systems. Through extensive testing and analysis, it has been determined that positioning wear guides at the leading and trailing ends of the foot, and in some embodiments extending beyond the foot's longitudinal boundaries, provides exceptional performance in inhibiting detrimental edge contact between the foot and track. This placement addresses a critical failure mode in conventional systems where the leading and trailing edges of the foot become primary contact points during translation and articulation, resulting in concentrated wear, galling, and binding that severely impedes smooth operation. This makes the systems difficult to use and significantly reduces their life cycle.

The remarkable improvement in translation ease achieved through this end-positioned configuration stems from the wear guides' ability to shield these vulnerable edge areas from direct metal-to-metal contact during movement. This includes all areas between the foot and the track that could contact each other When the foot undergoes slight articulation or angular displacement within the track—a common occurrence during loading, unloading, and adjustment operations—the wear guides positioned at each end act as protective barriers, preventing the sharp edges of the foot from gouging, binding, or digging into the track surfaces.

The present invention achieves superior performance by strategically positioning wear guide elements at each end of the foot, thereby creating a comprehensive protective interface that inhibits problematic contact between any portion of the foot edges and the track during translation operations. This configuration results in a substantial reduction in operational friction, effectively eliminating the binding and edge wear characteristic of traditional metal-on-metal interfaces, and providing enhanced translation characteristics that significantly improve both operational performance and component service life. The strategic placement of wear guides at the foot ends addresses the root cause of edge-related failures in conventional systems, where concentrated contact forces at the leading and trailing edges create localized wear patterns that progressively degrade system performance. By intercepting these contact forces through the dissimilar material interface provided by the strategically positioned wear guides, the present invention maintains smooth operational characteristics throughout the service life of the system while protecting the more expensive structural components from premature wear and replacement.

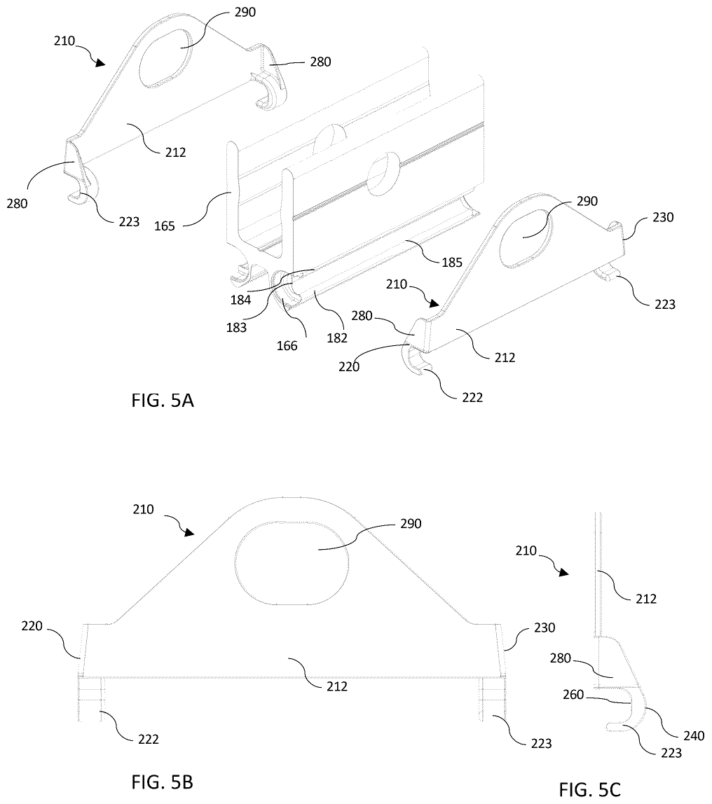

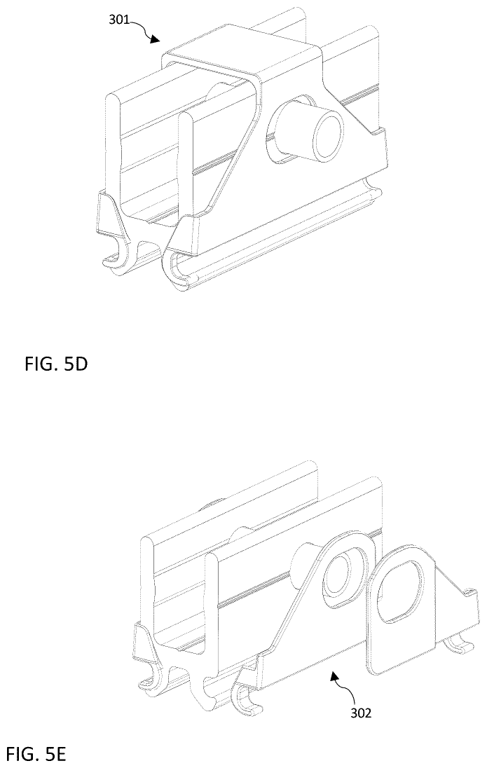

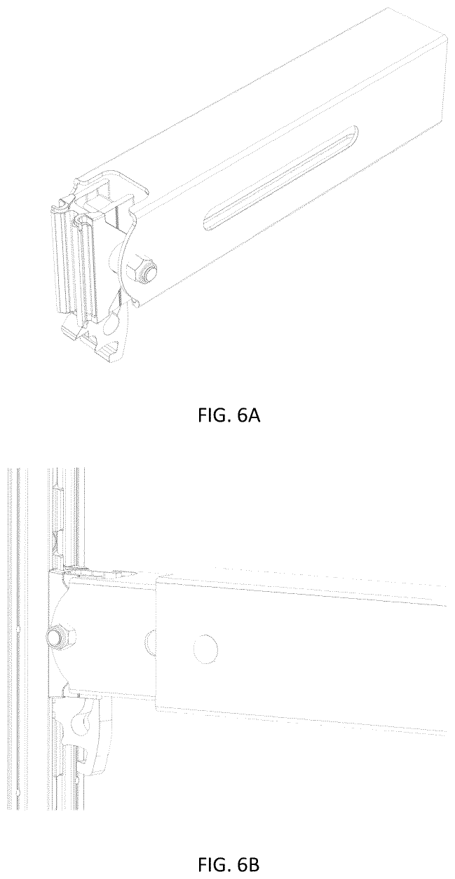

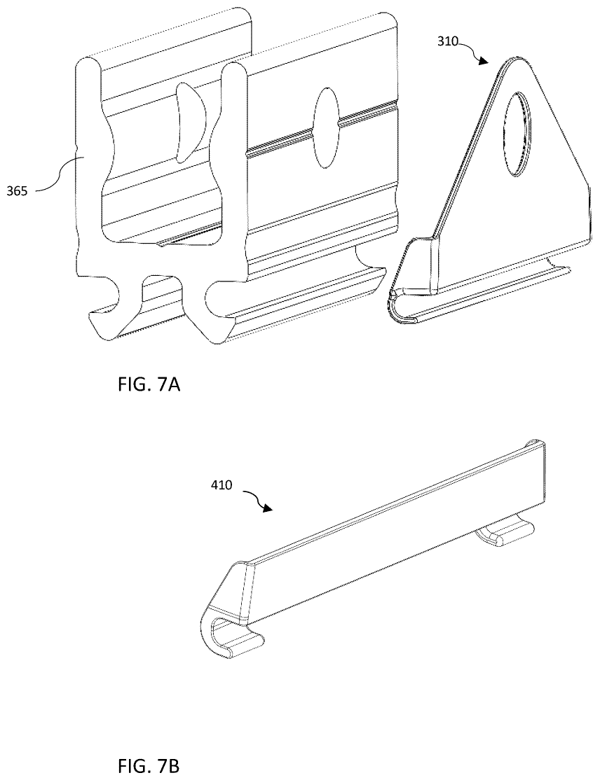

The wear guide of the present invention incorporates several innovative features, including a through-hole configuration for receiving mounting bolts (as shown in FIGS. 5A-5C) and an end cap retention system that secures the wear guide in position relative to the footing (as illustrated in FIGS. 6A-7B). These features contribute to the system's ease of installation, secure positioning, and simplified maintenance. However, the present invention is not limited to these specific attachment methods and a person of skill in the art and familiar with this disclosure will understand that other methods may be used. Alternative securement approaches may include, but are not limited to: press-fitting arrangements where the wear guide is dimensioned to create an interference fit with corresponding features on the footing; mechanical fastening using screws, rivets, clips, or other discrete fasteners; adhesive bonding using structural adhesives, epoxies, or other suitable bonding agents; interlocking geometries such as dovetail connections, bayonet-style couplings, or twist-lock mechanisms; magnetic attachment systems; snap-fit connections utilizing flexible tabs or resilient elements; threaded engagement where portions of the wear guide engage with threaded features on the footing; welding or brazing for permanent attachment; over-molding where the wear guide material is molded directly onto the footing; insert molding where the footing includes embedded features that capture the wear guide; compression fittings that utilize elastic deformation for retention; keyed connections that prevent rotational movement; sliding rail systems; spring-loaded retention mechanisms; cam-actuated locking systems; and combinations of any of the foregoing methods. The choice of attachment method may be determined by factors including operational requirements, maintenance accessibility, environmental conditions, load characteristics, and manufacturing considerations. These various securement features contribute to the system's ease of installation, secure positioning, and simplified maintenance while providing flexibility in implementation across different applications and operational environments.

While the primary application of the present invention is in cargo track systems for freight transportation, the principles and benefits of the wear guide can be extended to various track-based systems across multiple industries where similar challenges of friction, wear, and binding are encountered. The modular and adaptable nature of the invention makes it suitable for both new installations and as a retrofit solution for existing systems, thereby offering wide-ranging utility and application.

In the following sections, the specific components, materials, configurations, and benefits of the wear guide system will be described in greater detail, with reference to the exemplary embodiments shown in the accompanying drawings.

In reference to FIGS. 4A-4B and 5A-5C, a wear guide 210 in accordance with one embodiment of the present invention is shown. The wear guide 210 is designed for use with an adjustable decking system that includes a foot 165 having an engagement portion 182 and a track 190 defining a guide recess 192. The engagement portion 182 extends between a first end and a second end along a first direction and has a cross-section defining an open channel configuration. This open channel includes a base portion 183 and opposing first and second arms 184, 185 extending from opposite ends of the base portion to define an opening therebetween, creating a generally C-shaped or U-shaped cross-sectional profile that is characteristic of many cargo track interface designs. This channel configures extends along the length of the foot from the first end to the second end.

This channel configuration allows the engagement portion 182 to be received within the corresponding guide recess 192 of the track 190 while providing the structural geometry necessary for secure engagement and smooth translation along the track. The open channel design also creates specific edge areas at the ends of the foot proximate to the arms of the channel 184, 185 where problematic metal-to-metal contact is most likely to occur during operation.

The guide recess 192 is configured to receive the engagement portion 182 such that the foot 165 can translate in a first direction along a length of the track 190 and be selectively fixed relative to the track in said first direction while being constrained relative to the track in a second direction and a third direction. The second direction extends perpendicular to the first direction in a common plane, and the third direction extends normal to the plane.

It should be understood that the term “foot” as used throughout this disclosure may be interchangeably referred to as a “head,” “sliding head,” “track head,” or “engagement head” in the art, and those skilled in the field will recognize these terms as referring to the same fundamental component. The foot/head represents the terminal portion of the adjustable beam that interfaces with the vertical track system, incorporating the engagement features necessary for secure positioning and smooth translation along the track. Regardless of the specific terminology employed by different manufacturers or industry segments, the functional characteristics and operational requirements of this component remain consistent, and the present invention is equally applicable to all such foot/head configurations.

While the exemplary embodiment illustrated in the figures depicts specific track and engagement configurations, those skilled in the art will appreciate that cargo track systems employ a wide variety of track profiles and corresponding engagement geometries. Common track configurations include, but are not limited to: E-track systems with horizontal slots, vertical slotted tracks, C-channel profiles, dovetail channels, T-slot configurations, recessed channel designs, and proprietary track geometries developed by various manufacturers. Correspondingly, the engagement portions of the feet may incorporate diverse features such as spring-loaded locking mechanisms, cam-operated retention systems, threaded engagement elements, wedge-type lockers, pin-and-hole arrangements, lever-actuated clamps, and various hook or tab configurations designed to interface with their respective track systems. The guide recesses defined by these tracks similarly vary in geometry, including rectangular channels, curved profiles, angled surfaces, stepped configurations, and compound geometries. The present invention is not limited to any particular track or engagement configuration, as the fundamental principle of providing a protective interface between the track and the foot through strategically positioned wear guides is universally applicable across all such track and foot combinations, regardless of their specific geometric characteristics or operational mechanisms.

The wear guide 210 comprises a body 212 extending from a first end 220 to a second end 230. The body 212 defines a shape configured to be received on the foot 165 and positioned between the engagement portion 182 of the foot and the guide recess 192 of the track to form an interface therebetween.

In the embodiment disclosed, the body 212 is formed of a material dissimilar to the material of the foot and the material of the track, specifically polyoxymethylene (POM), which has a lower coefficient of friction than the materials of the foot and track. This material choice significantly reduces friction at the interface and prevents metal-on-metal contact that would otherwise lead to galling and binding, including leading edge and trail edge galling and wear. It should be understood that the present invention is not limited in this regard.

In one embodiment, the body 212 comprises interface members 222, 232 extending therefrom, wherein a first surface 240 is on one side of the interface members and a second surface 260 is on the other side. As clearly visible in FIG. 5C, the first surface 240 defines a convex arcuate surface 224 configured to contact the engagement portion 184 of the foot, while the second surface 260 defines a concave arcuate surface 226 configured to contact the guide recess 192 of the track. This is illustrated in FIG. 4C. This complementary curved design optimizes the contact interface and facilitates smooth translation.

The body 212 is substantially planar between the first end 220 and the second end 230. In the embodiment disclosed, the length of the wear guide 210 between the first end 220 and the second end 230 is substantially the same as a length of the foot 165. This dimensional correspondence ensures complete coverage of the interface between the foot 165 and the track 190, providing protection and wear reduction. However, the present invention is not limited to wear guides that extend the full length of the foot. In alternative embodiments, the wear guide may be configured with a length that is shorter than the foot, providing targeted protection at specific areas of the interface where wear is most problematic. For example, the leading and trailing edges of the translating foot. In some embodiments, the wear guide may include an interface member at only one end, such as at the first end 220 or the second end 230, while omitting interface features at the opposite end. Such single-end configurations may be particularly advantageous in applications where predominant wear occurs at one specific end of the foot due to directional loading patterns or operational characteristics. Additionally, in certain embodiments, the wear guide may be designed to protect only one end of the foot entirely, providing a localized protective interface at either the leading or trailing edge where edge contact and binding are most severe. These variations in length and interface positioning allow the wear guide system to be optimized for specific operational requirements, wear patterns, and cost considerations while maintaining the fundamental benefit of preventing detrimental metal-to-metal contact at critical interface locations. It should be noted, however, that in the embodiment disclosed in FIGS. 4A-5C, the interface members 222, 232 are only disposed at the first end 220 and the second end 230 of the wear guide 210. This configuration provides support at the critical load-bearing points. It should be understood, however, that the present invention is not limited in this regard. For example, in some embodiments of the present invention, the interface member extends along the entire length of the wear guide, providing continuous support and protection along the full interface between the foot 165 and track 190. This continuous interface configuration may be advantageous in high-load applications or environments with particularly severe operating conditions.

In yet other embodiments of the present invention, the interface members may be positioned at strategic intermediate locations along the length of the wear guide 210, rather than only at the ends or continuously throughout. Such strategic placement can be engineered to address specific wear patterns or load distributions that may occur in particular applications of the decking system. The flexibility in configuration of the interface members allows the wear guide 210 to be optimized for different operational requirements while maintaining its core functionality of reducing friction and preventing wear at the foot-track interface.

In certain embodiments of the present invention, for example as shown in FIGS. 4A-4D, the wear guide and its interface members may be configured to extend longitudinally beyond the physical boundaries of the foot, projecting past either the leading end, trailing end, or both ends of the foot along the axis of translation. This extended configuration ensures that an effective protective interface is maintained between the track and foot through all potential points of contact, even when the foot undergoes angular displacement, articulation, or slight misalignment within the track during operation. By extending beyond the foot's termination points, the wear guide preemptively intercepts any contact that might otherwise occur between the foot's edges and the track surfaces, thereby preventing the concentrated edge loading that leads to galling, binding, and accelerated wear. This is particularly important at the area proximate to the opposing first and second arms extending from opposite ends of the base portion in the channel.

In some embodiments of the present invention, the wear guide incorporates flanges that provide enhanced protection for the vulnerable edge areas of the foot's engagement portion. These flanges are strategically positioned at one or both ends of the wear guide body and project in the third direction (normal to the plane of translation) to cover and protect the edges of the foot at the area of the open channel. The flanges may 280 extend along respective portions of the first arm and second arm of the engagement portion, effectively shielding the distal edges thereof from direct contact with the track surfaces. This flange configuration is particularly advantageous in preventing the sharp edges of the opposing arms from gouging, scraping, or binding against the track during translation and articulation movements. The flanges essentially create a protective barrier that intercepts potential contact forces before they can reach the metal edges of the foot, thereby preventing the concentrated edge loading that leads to galling, binding, and accelerated wear in conventional systems. In certain embodiments, the flanges may be formed as integral extensions of the wear guide body, while in other embodiments they may be separately manufactured components that are attached or assembled to the main body structure. The dimensional characteristics of the flanges, including their projection distance and coverage area, can be optimized based on the specific geometry of the foot and track system to ensure comprehensive protection while maintaining proper clearances for smooth operation.

In certain embodiments of the present invention, the wear guide includes flanges at an end thereof that extend in the third direction along respective portions of the first arm and the second arm of the engagement portion to protect the distal edges thereof. These flanges provide coverage of the vulnerable edge areas where the opposing arms of the open channel are most susceptible to direct contact with the track surfaces during translation and articulation movements. The flanges create a protective envelope that shields the edge of the channel from metal-to-metal contact, effectively preventing the concentrated edge loading and binding that occurs when the sharp edges of the arms contact the track.

Furthermore, in additional embodiments, the dimensional profile of the wear guide may extend radially outward beyond the corresponding dimensional boundaries of the foot as measured perpendicular to the axis of translation. This radial extension ensures that the wear guide's protective interface completely envelops the engagement surfaces of the foot, creating a comprehensive barrier that prevents direct metal-to-metal contact regardless of the specific contact angle or interface geometry that may develop during normal operational movements. Such radial extension is particularly beneficial in accommodating manufacturing tolerances, thermal expansion effects, and operational variations that might otherwise allow portions of the foot to make direct contact with the track. This comprehensive dimensional approach-both longitudinal and radial extension-ensures that the wear guide maintains an effective protective interface between the track and foot through all conceivable points of contact, thereby maximizing the protective benefits and operational improvements provided by the present invention.

As discussed above, the interface members define opposing convex and concave arcuate surfaces. This is illustrated, for example, in FIG. 4B. In this manner, the interface members substantially conforms to the shape of the engagement projection 82, essentially forming an outer skin thereover.

In reference to FIG. 5A, the foot defines strategically positioned debossed or recessed sections at the first end and the second end that substantially conform to the dimensional profile, length, and width of each interface member. These precision-engineered debossed sections represent a significant advancement in foot design, being specifically configured to receive and retain each interface member such that the interface member is positioned nearly flush with the outer surface of the engagement portion when installed. This flush-mounted configuration provides several critical advantages: it maintains the overall dimensional envelope of the foot assembly, prevents snagging or interference during installation and operation, and ensures that the wear guide interface members are properly positioned to provide optimal contact with the track surfaces.

The debossed sections are carefully dimensioned to create a precise mating relationship with the interface members, providing both positioning accuracy and retention capability. In preferred embodiments, the system is designed so that the interface members have a thickness dimension that exceeds the depth of the corresponding debossed sections, ensuring that the interface members project slightly beyond the original engagement surface of the foot. This dimensional relationship guarantees that the interface members provide the primary—and in many cases, the sole—contact interface with the track, thereby inhibiting metal-to-metal contact and achieving the full protective benefits of the present invention. This is important at one or more of the leading edge and the trailing edge.

This innovative foot design strategy addresses a fundamental challenge in wear guide implementation: how to provide comprehensive protection while maintaining the structural integrity and load-bearing capacity of the foot. By incorporating the debossed sections directly into the foot's design, the present invention eliminates the need to remove material from critical load-bearing areas, preserving the foot's structural strength while creating dedicated accommodation spaces for the protective wear guide elements. The debossed sections are strategically positioned at the most vulnerable areas—the leading and trailing ends—where edge contact and binding are most problematic, ensuring maximum protective benefit where it is most needed.

The inventors have discovered that this debossed section approach provides exceptional compatibility with existing track systems, allowing the wear guide system to be implemented as either original equipment or as a retrofit solution without requiring modifications to established track geometries. The foot with integrated debossed sections maintains the same overall engagement characteristics as conventional feet, ensuring proper fit and function within existing track systems while providing the enhanced performance benefits of the wear guide interface. This compatibility aspect is particularly valuable for fleet operators and equipment manufacturers, as it allows the protective benefits of the present invention to be realized across existing installations without the cost and complexity of track system modifications.

Furthermore, the precision-engineered nature of the debossed sections allows for tight control over interface member positioning and orientation, ensuring consistent contact patterns and wear characteristics throughout the operational life of the system. The recessed design also provides protection for the interface members themselves, shielding them from potential damage during handling, installation, and operation while maintaining their critical protective function at the foot-track interface.

In accordance with embodiments of the present invention, the wear guide 210 is selectively fixed to the foot 165 so that the wear guide translates with the foot relative to the track 190. This fixed relationship ensures that the wear guide consistently maintains its position at the critical interface between the engagement portion 184 and the guide recess 192, providing continuous protection against metal-on-metal contact, including against the leading and trail edge, during operation.

In the embodiment with the debossed sections and cooperating interface members 222, 232, the interface members create a precise dimensional relationship with the debossed sections of the foot 165. This relationship provides a degree of self-positioning force that helps maintain proper alignment during installation and operation. The geometry of the interface members 222, 232 is specifically designed to mate with the corresponding debossed sections, creating a complementary fit that naturally guides the wear guide 210 into its optimal position relative to the foot 165.

As shown particularly in FIG. 5A, the body 212 further comprises retention features to secure it to the foot 165. These retention features include end caps 280 (also referred to as flanges) extending from the body and configured to wrap around portions of the foot, providing a secure mechanical connection. The end caps 280 are dimensioned to create a slight interference fit with the foot 165, ensuring positive retention without requiring additional fasteners. Importantly, these end caps serve to protect the leading and trail edges from metal-metal contact metal during operation, which is a primary feature of the design. This design allows for secure positioning while maintaining the ease of field replacement when necessary.

Additionally, the body 212 may include a through-hole 290 configured to receive a fastener that secures the foot 165 to a beam 40 of the adjustable decking system. This dual retention system ensures that the wear guide 210 remains firmly fixed relative to the foot 165 when the foot translates in the first direction relative to the track 190. The through-hole 290 is strategically positioned to align with existing fastener locations in standard decking systems, allowing the wear guide 210 to integrate with established assembly procedures without requiring additional drilling operations or specialized fasteners. This integration minimizes installation complexity while maximizing retention security.

In reference to FIG. 5D, an alternate embodiment of the present invention is shown, wherein the wear guide 302 extends along the entire length of the channel from the first end to the second end. In reference to FIG. 5D, an alternate embodiment of the present invention is shown, wherein the wear guide 303 comprises two separate pieces.

FIG. 6A is a perspective view of one embodiment of a wear guide in accordance with the present invention, wherein the wear guide is received on the footing. FIG. 6B is a perspective view of the wear guide and footing shown in FIG. 6A, wherein the footing is received in a track and the wear guide provides an interface therebetween.

In reference to FIG. 7A, an alternate embodiment of the present invention is shown, wherein the interface member extends along the entire length of the body. In this embodiment disclosed, there is no embossed sections in the footing. In reference to FIG. 7B, an embodiment is disclosed where the body does not extend to an apex having a through hole.

The edges of the body 212 are beveled or radiused to facilitate smooth translation along the track, reducing potential catching points and enhancing operational smoothness. This careful attention to the geometry of the wear guide contributes to its overall effectiveness in reducing friction and wear while enabling smooth movement of the decking system components. However, the present invention is not limited to any specific edge treatment or geometric configuration. Alternative edge treatments may include, but are not limited to: chamfered edges at various angles, compound radius profiles, stepped edge configurations, tapered transitions, curved blends, angled facets, and combinations thereof. In some embodiments, the edges may incorporate relief cuts, grooves, or other geometric features designed to reduce contact pressure or accommodate specific track geometries.

The present invention encompasses wear guides with sharp edges, squared edges, or any other edge configuration that provides the fundamental benefit of creating a protective interface between the foot and track. While beveled or radiused edges may enhance operational smoothness in many applications, the core inventive concept—providing a dissimilar material interface to prevent metal-to-metal contact and reduce wear—is achieved regardless of the specific edge treatment employed. The edge geometry may be selected based on manufacturing considerations, material properties, operational requirements, track compatibility, or cost factors without departing from the scope of the present invention.

Furthermore, different portions of the wear guide may incorporate different edge treatments. For example, the leading edges may be beveled for smooth entry into the track, while trailing edges may have different geometric characteristics optimized for other operational considerations. The flexibility in edge design allows the wear guide to be optimized for specific applications while maintaining the essential protective function that defines the present invention.

When installed between the foot 165 and track 190, the wear guide 210 creates an effective buffer that isolates dissimilar materials and, as its primary focus, prevents metal-to-metal contact on the leading and trail edges. This reduces operational friction and binding, thereby extending the service life of both the foot and track components. The wear guide 210 is field-replaceable without requiring replacement of the more expensive parts. In one embodiment, the wear guide 210 is constructed from polyoxymethylene (POM), a high-performance engineering thermoplastic specifically chosen for its properties in this application. POM offers an combination of low friction, high strength, and excellent dimensional stability, making it particularly well-suited for use at the interface between the foot 165 and track 190.

While POM represents an embodiment, the present invention is not limited to this specific material. Alternative materials may be employed. Suitable alternatives include, but are not limited to, other engineering plastics (such as ultra-high-molecular-weight polyethylene, nylon, or polyetheretherketone), certain ceramics, or selected metals with appropriate surface treatments.

It has been found that using a dissimilar material inhibits the galling and binding that that may occur with metal-on-metal interfaces. When similar metals slide against each other, microscopic welding can occur at contact points, leading to material transfer, surface damage, and ultimately component failure. By introducing a dissimilar material interface, the wear guide 210 effectively eliminates this problematic interaction.

The low coefficient of friction of the wear guide contributes to smooth operation and reduced operational force requirements. The POM material typically exhibits a coefficient of friction approximately 60-80% lower than metal-on-metal contact, significantly enhancing the ease of movement in the cargo track system. However, the present invention is not limited to POM as the wear guide material. Alternative materials that provide suitable friction reduction and wear resistance characteristics may be employed without departing from the scope of the invention. Such alternative materials include, but are not limited to: high-density polyethylene (HDPE), which offers excellent chemical resistance and low friction properties; ultra-high-molecular-weight polyethylene (UHMWPE), known for its exceptional wear resistance and self-lubricating characteristics; polytetrafluoroethylene (PTFE) and PTFE-filled compounds, which provide extremely low coefficients of friction; nylon and its various formulations, including glass-filled and molybdenum disulfide-filled variants; polyetheretherketone (PEEK) for high-temperature applications; polyphenylene sulfide (PPS) for enhanced chemical resistance; acetal copolymers; polyurethane elastomers; and various engineering thermoplastics with appropriate tribological properties.

The selection of wear guide material may be influenced by factors such as operating temperature ranges, chemical exposure conditions, load requirements, environmental considerations, cost constraints, and specific performance objectives. Composite materials incorporating reinforcing fibers, self-lubricating additives, or wear-resistant fillers may also be employed to optimize performance characteristics for particular applications. Additionally, the wear guide material may incorporate various additives such as graphite, molybdenum disulfide, PTFE particles, glass fibers, carbon fibers, or other reinforcing or lubricating agents to enhance specific performance attributes. The fundamental requirement is that the selected material provides a lower coefficient of friction than the metal-to-metal interface it replaces while possessing sufficient mechanical properties to withstand the operational loads and environmental conditions encountered in the intended application. This material flexibility allows the wear guide system to be optimized for diverse operational environments and performance requirements while maintaining the core benefits of reduced friction, wear prevention, and extended component life.

In addition to low friction, the wear guide material possesses high impact resistance to withstand the dynamic loads encountered during cargo handling operations. This impact resistance prevents cracking or fracturing even under sudden loading conditions. The high tensile strength of the selected material ensures the wear guide 210 maintains its structural integrity under the substantial loads transmitted through the decking system.

In one embodiment of the present invention, the base material incorporates additives or reinforcements. For example, glass fibers can be added to POM to increase strength and rigidity, while PTFE additives can further reduce the coefficient of friction. These modifications allow the wear guide properties to be tailored to specific operational requirements while maintaining the fundamental benefits of the system.

The geometry of the wear guide 210 is not limited to any specific form, allowing for versatile applications and adaptability to different track designs. As shown in FIGS. 5A-5C, the wear guide body 212 incorporates interface members 222, 232 that can be configured to match specific foot and track profiles. The first surface 240 and second surface 260 can be shaped with convex 224 and concave 226 arcuate profiles to maximize contact area and distribute loads effectively.

To further support smooth translation, the edges of the wear guide 210 are beveled or radiused, eliminating potential catch points that could impede movement. The specific edge treatment depends on the manufacturing method used and the operational requirements of the system.

The wear guide system offers flexible implementation options. In one embodiment of the present invention the wear guide 210 is positioned on one side of the interface. However, alternative embodiments may incorporate wear guides on both sides of the head/track interface, providing balanced protection.

The wear guide 210 can be manufactured using various processes, with the specific method chosen based on material selection, production volume, and geometric complexity requirements.

Injection molding represents may be used for producing the wear guide 210 when using thermoplastic materials such as POM. This process offers several advantages, including high production rates, excellent dimensional consistency, and the ability to create complex geometries in a single operation. The injection molding process involves heating the polymer to its melting point, injecting it under pressure into a mold cavity that defines the wear guide shape, and allowing it to cool and solidify before ejection.

In one embodiment of the present invention, the wear guide 210 is manufactured using machining processes. Computer Numerical Control (CNC) milling and turning operations can be employed to create the wear guide from solid stock material. This approach offers greater flexibility for customization and avoids the tooling costs associated with injection molding.

The through-hole 290 and end cap 280 features require specific manufacturing considerations. In one embodiment of the present invention, these features are formed directly during the molding process, with appropriate core pins and slides in the mold tooling. The design accounts for proper draft angles to facilitate part ejection without damage to these features.

In one embodiment of the present invention, the through-hole 290 is produced using precision drilling operations, potentially followed by reaming to achieve the required dimensional tolerance for fastener fit. The end caps 280 may be machined from the solid material or, in some embodiments, created as separate components and attached to the main body 212 during a secondary assembly operation.

The wear guide system offers multiple installation options to suit various operational needs and existing track designs.

In one embodiment of the present invention, the wear guide 210 is installed via loose placement between the foot 165 and track 190. This method relies on the physical constraint provided by the surrounding components to keep the wear guide in position during operation. The geometry of the wear guide, particularly the end caps 280, helps maintain proper alignment during installation and operation.

As shown in FIGS. 5A-5C, the wear guide 210 incorporates a through-hole 290 that facilitates mechanical fastening. During installation, a fastener (typically a bolt) passes through this hole to secure both the wear guide and the foot 165 to the beam 40 of the decking system. This integrated fastening approach ensures that the wear guide remains properly positioned relative to the foot during translation movements.

In one embodiment of the present invention, the wear guide 210 is bonded directly to the foot 165 using appropriate adhesives. This method eliminates the need for mechanical fasteners and can provide a clean, streamlined installation.

In one embodiment of the present invention, the wear guide 210 is designed to be installed using a friction fit approach. In this method, the wear guide is dimensioned to provide a slight interference fit with mating features on the foot 165, creating sufficient retention force through friction to maintain proper positioning during operation.

The end caps 280 shown in FIGS. 5A-5C represent a specific installation method that combines elements of mechanical constraint and assembly joint approaches. During installation, these end caps are positioned to wrap around portions of the foot 165, creating a positive mechanical connection that resists displacement in multiple directions.

The wear guide 210, as described in this invention, is designed to function with both manual and self-propelled/automatic height adjustment heads. This versatility allows the same basic wear guide design to be implemented across a range of cargo handling equipment with different actuation mechanisms.

For manual adjustment systems, the wear guide 210 reduces the operational force required to move the foot 165 along the track 190, making height adjustments easier and more precise. By preventing leading and trail edge binding or dig-in, the wear guide ensures smoother motion. In self-propelled or automatic systems, the reduced friction provided by the wear guide allows for lower power requirements, potentially extending battery life or permitting the use of smaller drive motors.

A key advantage of the wear guide system is its retrofittability into existing cargo track installations. The wear guide 210 can be added to in-service equipment without requiring modification to the track 190 or significant alteration to the foot 165. This allows fleet operators to upgrade their equipment incrementally, addressing wear issues in the most problematic areas first if desired.

The retrofit process typically involves temporarily removing the foot 165 from the track 190, installing the appropriate wear guide 210, and reassembling the components. In most cases, this can be accomplished using standard maintenance tools and procedures, minimizing equipment downtime.

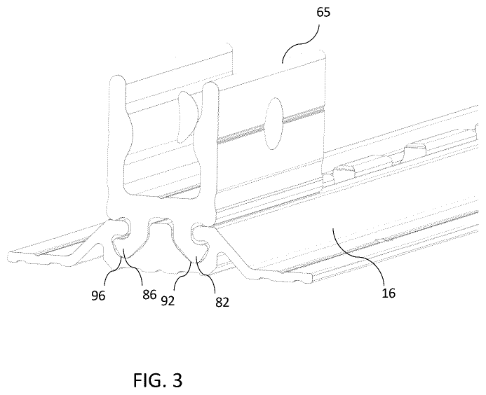

The concept of the wear guide 210 can be adapted to various track configurations and designs. While FIGS. 3A and 3B illustrate one specific track profile, the fundamental principle of providing a low-friction interface between dissimilar materials applies equally to alternatives such as dovetail channels, T-slot profiles, or other engagement geometries.

The wear guide body 212 and interface members 222, 232 can be designed to accommodate these different track profiles while maintaining the core functional benefits of reduced friction, wear prevention, and extended component life. This adaptability makes the wear guide concept applicable across a wide range of industries and cargo handling applications.

The mounting features of the wear guide 210, including the through-hole 290 and end caps 280, are designed to be adaptable to various footing designs while maintaining secure positioning. The specific dimensions and configurations of these features can be customized to match the particular requirements of different foot designs without altering the fundamental operating principle of the wear guide.

This adaptability extends to different fastening approaches as well. In one embodiment of the present invention, a single through-hole 290 is utilized, while alternative designs might incorporate multiple mounting points, different hole patterns, or entirely different retention approaches based on the specific requirements of the application.

The wear guide 210 is engineered to be easily replaceable in the field with minimal effort and basic tools. When the wear guide eventually shows signs of wear after extended service, maintenance personnel can quickly remove and replace it without the need for specialized equipment or extensive disassembly of the cargo handling.

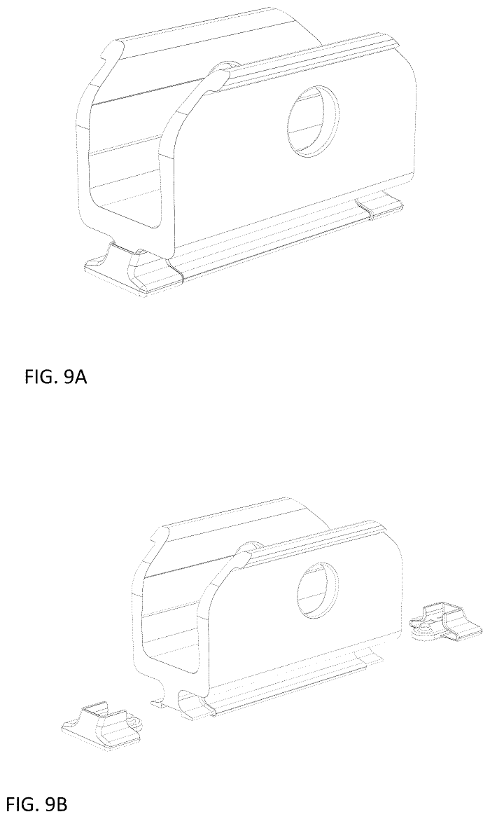

In reference to FIGS. 9A and 9B, an alternate embodiment of the present invention is shown, wherein the wear guide comprises a first interface component 910 and a second interface component 920 being separate and distinct from the first interface component. This multi-component configuration provides enhanced flexibility in manufacturing, installation, and maintenance while maintaining the protective benefits of the wear guide system. The foot defines an engagement portion that incorporates strategically positioned recesses or debossed sections at the first end and the second end, with each recess being specifically dimensioned to accommodate its corresponding interface component. The first interface component 910 is configured to be received in the recess at the first end and the second interface component 920 is configured to be received in the recess at the second end. The interface members define tabs to be received into the foot to fix the interface members to the foot. They may provide a snap fit or a fastener.

This segmented approach offers several distinct advantages over single-piece wear guide configurations. Each interface component can be independently manufactured, installed, replaced, and maintained, allowing for targeted servicing of only the components that show wear rather than requiring replacement of the entire wear guide assembly. The separate components also facilitate easier installation in confined spaces where a full-length wear guide might be difficult to position properly. Additionally, this configuration allows for the use of different materials or material formulations for each interface component, enabling optimization of wear characteristics based on the specific operational demands at each end of the foot.

As illustrated in FIG. 9A, the interface components 910, 920 are shown in their installed positions within their respective recesses, demonstrating how they integrate with the foot structure while maintaining the protective interface function. FIG. 9B shows the components in an exploded or separated view, clearly illustrating the individual nature of each component and their relationship to the foot structure. The arrow indicated by reference numeral 310 demonstrates the direction of installation or removal of the interface components relative to their corresponding recesses.

Each interface component incorporates the same fundamental design principles as the single-piece embodiments, including surfaces configured to contact both the engagement portion of the foot and the guide recess of the track, thereby maintaining the dissimilar material interface that prevents metal-to-metal contact. The components may include retention features such as interference fits, mechanical fasteners, or interlocking geometries to ensure secure positioning during operation while allowing for serviceability when required. This modular approach extends the versatility of the wear guide system while preserving all the operational benefits of friction reduction, wear prevention, and extended component life.

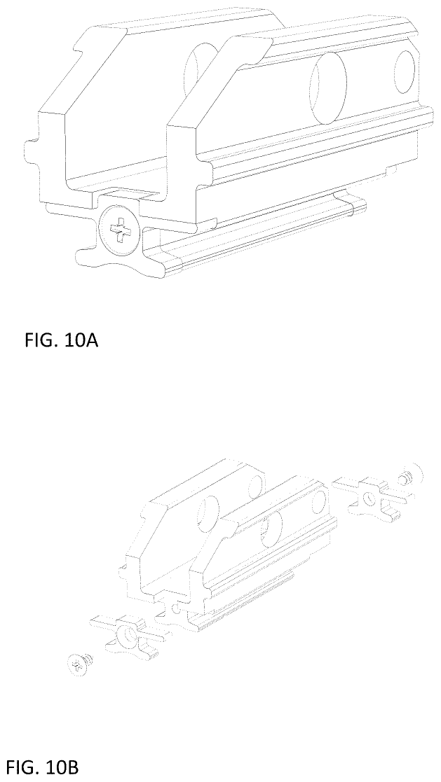

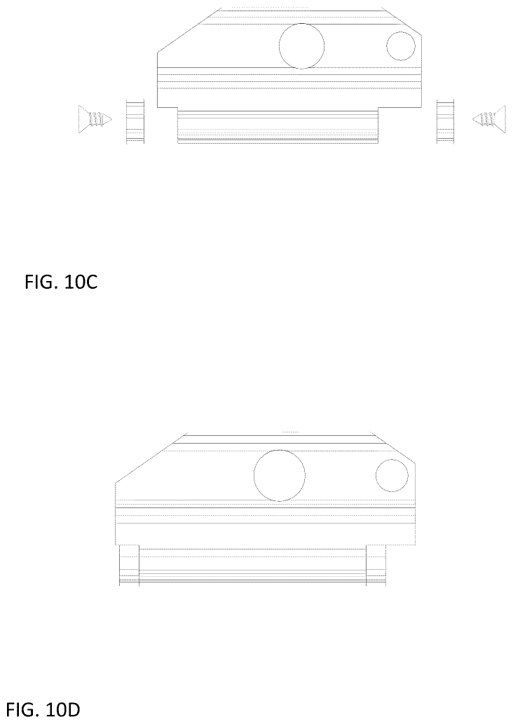

In reference to FIGS. 10A-10D, another alternate embodiment of the present invention is shown, wherein the wear guide system comprises multiple discrete interface components that provide protection at contact points along the foot-track interface. This multi-component configuration represents a further refinement of the modular approach, offering enhanced flexibility in addressing specific wear patterns and operational requirements while maintaining the fundamental protective benefits of the wear guide system.

As illustrated in FIG. 10A, the assembled configuration shows the foot with multiple interface components positioned at strategic locations to provide targeted protection where metal-to-metal contact is most likely to occur.

FIG. 10B provides an exploded view of the multi-component system, clearly illustrating the individual nature of each interface component and their spatial relationship to the foot structure and to each other. The exploded view demonstrates how each component is configured to address specific contact zones, allowing for customized protection based on empirical wear data or predictive analysis of contact patterns. The discrete components may include end-mounted interface elements similar to those shown in previous embodiments. In the embodiment disclosed, longitudinally extending fasteners are used at either end to fix the wear guide to the foot.

This multi-component approach offers several distinct advantages over both single-piece and two-piece configurations. Each interface component can be independently optimized for its specific location and contact conditions, potentially using different materials, geometries, or surface treatments based on the localized operational demands. The system allows for selective replacement of only those components showing wear, reducing maintenance costs and minimizing downtime. Additionally, the modular nature facilitates easier inventory management and field service, as technicians can carry a smaller selection of specific components rather than complete assemblies.

The individual components may incorporate various retention mechanisms, including mechanical fasteners, interference fits, snap-lock connections, or adhesive bonding, depending on the specific requirements of each location. The fastener shown in the exploded view indicates one method of securing components to the foot structure while maintaining the ability to service individual elements as needed. This comprehensive modular approach extends the versatility and serviceability of the wear guide system while preserving all operational benefits of friction reduction, wear prevention, and extended component life across multiple contact zones. The present disclosure describes aspects of the present invention with reference to the exemplary embodiments illustrated in the drawings; however, aspects of the present invention are not limited to the exemplary embodiments illustrated in the drawings. It will be apparent to those of ordinary skill in the art that aspects of the present invention include many more embodiments. Accordingly, aspects of the present invention are not to be restricted in light of the exemplary embodiments illustrated in the drawings. It will also be apparent to those of ordinary skill in the art that variations and modifications can be made without departing from the true scope of the present disclosure. For example, in some instances, one or more features disclosed in connection with one embodiment can be used alone or in combination with one or more features of one or more other embodiments.

What is claimed is:

1. A wear guide for use with an adjustable decking system, the decking system including a foot having an engagement portion and a track defining a guide recess configured to receive the engagement portion such that the foot can translate in a first direction along a length of the track and be selectively fixed relative to the track in said first direction while being constrained relative to the track in a second direction and a third direction, the second direction extending perpendicular to the first direction in a common plane, and the third direction extending normal to the plane, the engagement portion extending between a first end and a second end along the first direction, the engagement portion having a cross-section defining an open channel, the channel including a base portion and opposing first and second arms extending from opposite ends of the base portion to define an opening therebetween, the wear guide comprising:
a body extending from a first end to a second end, the body defining a shape configured to be received on the foot and positioned between the engagement portion of the foot and the guide recess of the track to form an interface therebetween;
a first surface of the body configured to contact the engagement portion of the foot;
a second surface of the body configured to contact the guide recess of the track;
wherein the body remains fixed relative to the foot when the foot translates in the first direction relative to the track; and
wherein the first end of the body extends longitudinally beyond the first end of the engagement portion when the body is fixed to the foot.

2. The wear guide of claim 1, wherein the body defines a cross-sectional shape generally corresponding to the open channel of the engagement portion such that the body is received therein.

3. The wear guide of claim 1, wherein the body defines a flange at the first end, the flange extending in the third direction so as to cover a first edge of the foot at an area of the open channel.

4. The wear guide of claim 3, wherein the flange extends in the third direction along one or more of respective portions of the first arm and the second arm of the engagement portion to protect edges thereof.

5. The wear guide of claim 1, wherein the body includes an end cap extending from at least one of the first end and the second end, the at least one end cap being configured to wrap around an edge of the open channel of the engagement portion, including distal edges of the opposing first and second arms, so as to inhibit displacement of the wear guide relative to the foot and to prevent direct contact between the engagement portion and the track.

6. The wear guide of claim 5, wherein the body comprises end caps positioned at both the first end and the second end of the body.

7. The wear guide of claim 1, wherein the body is formed of a material dissimilar to a material of the foot and a material of the track, the material of the body having a coefficient of friction lower than that of the foot and the track.

8. The wear guide of claim 1, wherein the body is secured to the engagement portion by an interference fit between the body and the open channel of the engagement portion.

9. The wear guide of claim 1, wherein the body defines a through-hole configured to receive a fastener that secures the foot to a beam of the adjustable decking system.

10. An adjustable decking system comprising:
a foot having an engagement portion extending between a first end and a second end, the engagement portion having a cross-section defining an open channel, the channel including a base portion and opposing first and second arms extending from opposite ends of the base portion to define an opening therebetween;
a track defining a guide recess configured to receive the engagement portion such that the foot can translate in a first direction along a length of the track and be selectively fixed relative to the track in said first direction while being constrained relative to the track in a second direction and a third direction, the second direction extending perpendicular to the first direction in a common plane, and the third direction extending normal to the plane; and
a wear guide comprising a body positioned between the engagement portion of the foot and the guide recess of the track to form an interface therebetween, the body extending from a first end to a second end, the body defining a shape generally corresponding to the open channel of the engagement portion such that the body is received therein,
wherein the first end of the body extends longitudinally beyond the first end of the engagement portion when the body is fixed to the foot.

11. The adjustable decking system of claim 10, wherein the body defines a flange at the first end, the flange projecting in the third direction to cover a first edge of the foot at an area of the open channel.

12. The adjustable decking system of claim 11, wherein the flange extends along one or more of respective portions of the first arm and the second arm of the engagement portion to protect distal edges thereof.

13. The adjustable decking system of claim 10, wherein the body comprises at least one end cap extending from at least one of the first end and the second end, the at least one end cap configured to wrap around an edge of the open channel of the engagement portion, including distal edges of the opposing first and second arms, so as to inhibit displacement of the wear guide relative to the foot and to prevent direct contact between the engagement portion and the track.

14. The adjustable decking system of claim 13, wherein the body comprises end caps positioned at both the first end and the second end of the body.

15. The adjustable decking system of claim 10, wherein the body defines at least one opening configured to receive a fastener that secures the foot to a beam of the adjustable decking system.

16. The adjustable decking system of claim 10, wherein the foot defines at least one recessed section dimensioned to receive a portion of the body such that the body is seated within the recessed section and projects beyond an original engagement surface of the foot to provide a primary contact interface with the track.

17. The adjustable decking system of claim 16, wherein the recessed section is located at the first end of the foot and is configured to receive a corresponding portion of the body.

18. The adjustable decking system of claim 17, wherein the foot defines a first recessed section at the first end and a second recessed section at the second end, each recessed section configured to receive a corresponding portion of the body.

19. The adjustable decking system of claim 16, wherein the recessed section has a depth less than a thickness of the corresponding portion of the body such that the body projects beyond the original engagement surface of the foot when installed.

20. The adjustable decking system of claim 16, wherein the recessed section and the body are configured such that the body provides a sole contact interface between the engagement portion of the foot and the guide recess of the track at at least one predetermined contact zone.

21. A wear guide for use with an adjustable decking system, the decking system including a foot having an engagement portion and a track defining a guide recess configured to receive the engagement portion such that the foot can translate in a first direction along a length of the track and be selectively fixed relative to the track in said first direction while being constrained relative to the track in a second direction and a third direction, the second direction extending perpendicular to the first direction in a common plane, and the third direction extending normal to the plane, the engagement portion extending between a first end and a second end along the first direction, the engagement portion having a cross-section defining an open channel, the channel including a base portion and opposing first and second arms extending from opposite ends of the base portion to define an opening therebetween, the wear guide comprising:
a body extending from a first end to a second end, the body defining a shape configured to be received on the foot and positioned between the engagement portion of the foot and the guide recess of the track to form an interface therebetween;
a first surface of the body configured to contact the engagement portion of the foot;
a second surface of the body configured to contact the guide recess of the track; and
a flange defined at the first end of the body, the flange projecting in the third direction to cover a first edge of the foot at an area of the open channel.

22. The wear guide of claim 21, comprising a second flange wherein the flanges extend along respective portions of the first arm and the second arm of the engagement portion to protect distal edges thereof.

23. The wear guide of claim 21, wherein the body defines at least one opening configured to receive a fastener that secures the foot to a beam of the adjustable decking system.
